(19) United States
(12) Patent Application Publication
(10) Pub. No.: US 2006/0151967 A1
(43) Pub. Date: Jul. 13, 2006

(54) Apparatus and method for transporting construction material

(76) Inventors: Perry F. Conway, Mesa, AZ (US); Melissa R. Conway, Mesa, AZ (US)

Correspondence Address: Mark F. Wright;Wright Law Group, PLLC, Suite 2, 7201 West Oakland, Chandler, AZ, 85226, US

(21) Appl. No.: 11/034,731

(22) Filed: Jan. 12, 2005

(51) Int. Cl. B62B 1/00

(52) U.S. Cl. 280/79.7

(57) ABSTRACT

The apparatus for transporting construction material described herein includes four primary components, an exterior, a liner for the exterior, a single wheel affixed to the bottom of the exterior and a handle coupled to the exterior. The handle is configured to be embedded within the interior space of the liner. The material to be transported is placed in the apparatus, contacting the liner, and wheeled to its destination. The handle may optionally be provided as a telescoping handle. Additionally, the apparatus may also include a coupling mechanism used to couple the apparatus to the operator's belt or to otherwise store the apparatus during times of non-operation.

### BACKGROUND OF THE INVENTION

1. Technical Field

The present invention relates generally to the construction industry and more particularly to the transportation of large planar material, such as drywall, plywood and the like.

2. Background Art

Devices of various shapes and sizes have been designed and constructed for the purpose of transporting material that, due to the material's shape, weight, or dimensions, would otherwise be inconvenient to transport by less suitable means. Many such devices are specifically intended to transport large, planar material, typically produced in standard dimensions of 8′×10′ or larger. Of these devices, many comprise a platform supported by multiple wheels with side restraints for supporting the construction material in transit.

Many of these larger multi-wheeled devices include multiple wheels specifically to provide stability and support for balancing the construction material during transport. Yet, as a result of the relatively large size and significant amount of material used to construct such a device, the device itself is often heavy, bulky, awkward to maneuver, and difficult to transport. Accordingly, these larger devices are suitable for construction jobs that require the transport of large quantities of material over a longer period of time.

Conversely many single-wheeled devices, while relatively lightweight and maneuverable, provide less support for the construction material and minimal stability for larger loads. Additionally, operation of these smaller devices may prove to be awkward, primarily due the inherent lack of stability. In general, the smaller the device the smaller the amount of construction material that can be transported. This is especially important when transporting materials such as sheetrock due the very real possibility of inadvertently damaging the material during transport. Damage to the materials during transport is undesirable due to replacement costs and delays in procuring additional materials.

Regardless of the size or wheel configuration, many of the known devices presently provided for transporting construction materials are fabricated exclusively from metal or other similar material, providing a hard surface for supporting the construction material during transport. While providing a desired structural stability, the hard surface can potentially damage certain construction materials such as sheetrock.

Accordingly, among other characteristics, the optimal device for transporting large planar construction materials will be lightweight and maneuverable, and yet will also afford an adequate level of support and stability. While many of the known devices for transporting construction materials exhibit some of these characteristics, without further improvement, performance of these devices will continue to be suboptimal.

### BRIEF SUMMARY OF THE INVENTION

The present invention embodies the optimal characteristics of a large planar-material, transporting device as outlined above. According to the most preferred embodiments of the present invention, the subject device resembles an extruded “u-shape” and incorporates a centrically-positioned wheel to support the material being transported. The present invention is relatively small in size and is composed of moderately lightweight, yet highly durable, materials.

In the most preferred embodiments of the present invention, the interior portion of the transporting device is a liner fabricated from a high density plastic, polymer, foam, carpet, or similar material intended to contact the surface of the material to be transported without scratching, denting, or otherwise damaging the transported material. The liner is substantially surrounded by and attached to a rigid exterior surface that is designed to provide structural support for the liner and the material to be transported. In the most preferred embodiments of the present invention, the exterior is fabricated from a durable material such as a lightweight metal. The resulting configuration provides sufficient support for the intended applications, namely the transportation of drywall, plywood, or similar construction materials.

As a measure to ensure device stability during operation, an optional handle may be mounted or fixed to the apparatus. According to the most preferred embodiments of the present invention, the handle is a telescoping handle and is housed within the center of one side of the liner. Prior to operation, the grip portion of the telescoping handle is extended vertically upward and away from the apparatus. During operation, the user of the apparatus places one hand on the extended telescoping handle while directing and pushing the material with the other hand. Operating the apparatus in this manner allows the user to quickly and easily maneuver the apparatus and the construction material to the desired location while maintaining stability and maneuverability.

### BRIEF DESCRIPTION OF DRAWINGS

The preferred embodiments of the present invention will hereinafter be described in conjunction with the appended drawings, wherein like designations denote like elements, and:

FIG. 1 is a perspective view of an apparatus for transporting construction material in accordance with a preferred embodiment of the present invention;

FIG. 2 is a bottom view of an apparatus for transporting construction material in accordance with a preferred embodiment of the present invention;

FIG. 3 is a fragmentary front view of an apparatus for transporting construction material illustrating the attachment of a telescoping handle in accordance with a preferred embodiment of the present invention;

FIG. 4 is a side view of an apparatus for transporting construction material further illustrating the attachment of a telescoping handle in accordance with a preferred embodiment of the present invention; and

FIG. 5 is a perspective view of an apparatus for transporting construction material in accordance with a preferred embodiment of the present invention, illustrating the telescoping handle in the extended position.

### DETAILED DESCRIPTION

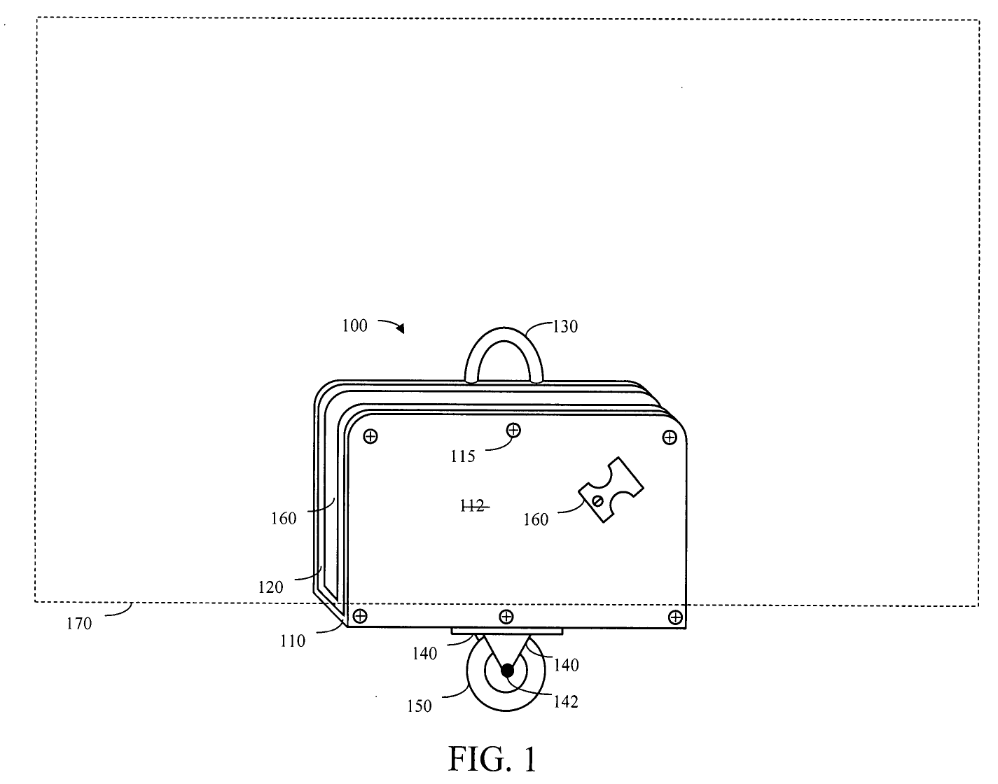

Referring now to FIG. 1, an apparatus for transporting construction material 100 in accordance with a preferred embodiment of the present invention most preferably comprises a liner 120, an exterior 110, a wheel support bracket 140, a single wheel 150, and an optional handle 130. The specific configuration of apparatus 100 is optimized for the transport of large planar objects such as construction material 170.

Liner 120 and exterior 110 are both substantially extruded u-shaped devices with two flat sides and a flat bottom. Liner 120 “nests” inside of exterior 110 and is affixed to exterior 110 so as to form a single unit or body. In the most preferred embodiments of the present invention, exterior 110 and liner 120 are fabricated from different materials with exterior 110 being substantially harder than liner 120 and liner 120 being substantially more resilient than exterior 110.

Liner 120 is most preferably fabricated from a durable plastic or polymer, high-density durable foam, or similar resilient material and is intended to uniformly support construction material 170 without scratching, denting, or otherwise damaging construction material 170. In one of the preferred embodiments of the present invention, liner 120 is comprised of three pieces; the first piece sized to cover the bottom interior face of exterior 110 and the remaining two pieces sized to cover the front and back interior faces of exterior 110. In another most preferred embodiment of the present invention, liner 120 is comprised of a single piece of material that coats or covers the entire interior surface of exterior 110. In at least one preferred embodiment of the present invention, liner 120 is a spray-on liner material affixed in a manner similar to the fabrication of spray-in bed liners for pickup trucks.

Exterior 110 is most preferably fabricated from a rigid, metallic material intended to provide structural support while transporting device 100 is in operation. In accordance with one of the most preferred embodiments of the present invention, exterior 110 is formed from treaded aluminum or steel and is affixed to liner 120 by a series of screws 115. The length of screws 115 is selected so that when screws 115 are inserted through the surface of exterior 110 and into the body of liner 120, the pointed ends of screws 115 will not entirely penetrate the body of liner 120.

Wheel support bracket 140 is affixed to the bottom of apparatus 100 and is used to attach wheel 150 to apparatus 100. Exterior 110 is sized and proportioned such that material 170 may be easily transported in a vertical fashion, easily removed and inserted into apparatus 100, and easily retained within apparatus 100 during operation. By using a single wheel as both a pivot point and a rolling mechanism, the required ability to transport construction material 170 is provided while offering the maximum amount of maneuverability. In operation, once construction material 170 has been placed in liner 120, the operator of apparatus 100 can grasp construction material 170 and use it to guide both apparatus 100 and the transported construction material 170 to the desired location.

Additionally, for the most preferred embodiments of the present invention, as shown in FIG. 1 where construction material 170 represents a standard 4′ by 8′ piece of sheetrock, the overall height of apparatus 100 is less than ½ the height of construction material 170 and the overall width of apparatus 100 is less then ½ the width of construction material 170. This small size also contributes to making apparatus 100 very lightweight, maneuverable and easy to operate.

Handle 130 is provided for several different purposes. In the first instance, handle 130 may be used to lift and carry apparatus 100 to and from the job site where it is to be utilized. Additionally, handle 130 may be used to hang apparatus 100 from a hook on the wall or in the ceiling for storage purposes. Finally, handle 130 may be used by the operator of apparatus 100 to maneuver apparatus 100 when transporting construction material 170 to the desired location. In the most preferred embodiments of the present invention, handle 130 is fabricated from a lightweight yet durable metal and is provided as a telescoping handle. In this embodiment, handle 130 can be selectively extended or retracted into or out of the body of liner 120 as desired by the operator of apparatus 100. Telescoping handle 130 is similar to the type of handle used in airline baggage. For those embodiments of the present invention where handle 130 is not provided as a telescoping handle, the legs of handle 130 are simply fixed to apparatus 100 by screws, welding, or some other suitable attachment mechanism.

According to one of the most preferred embodiments of the present invention, apparatus 100 further comprises a coupling mechanism 160 which is used to couple transporting device 100 to the operator's work belt or toolbox. Coupling mechanism 160 may be a clip, hook, button, toggle, snap, or any similar mechanism known to those skilled in the art. Coupling mechanism 160 is most preferably securely affixed to the exterior surface of exterior 110 via screws or some other mounting process known to those skilled in the art.

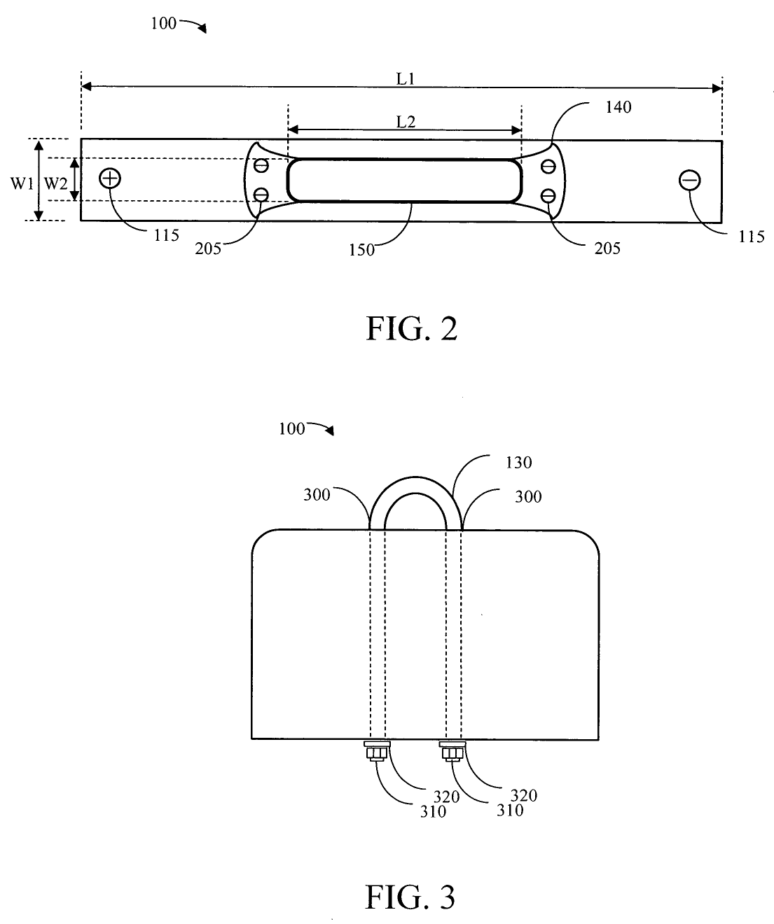

Referring now to FIG. 2, a bottom view of apparatus 100 from FIG. 1 is shown. As previously mentioned, wheel support bracket 140 is affixed to the bottom exterior surface of apparatus 100. In this specific embodiment, wheel support bracket 140 is affixed to apparatus 100 using one or more attachment screws 205. According to the most preferred embodiments of the present invention, wheel support bracket 140 is formed from a metal such as a steel alloy that is capable of structurally supporting a weight greater than the maximum load intended to be born by wheel support bracket 140 and apparatus 100.

Additionally, apparatus 100 has a width W1 and a length L1. Similarly, wheel 150 had a length L2 and a width W2. In the most preferred embodiments of the present invention, length L2 is approximately ⅓ of L1 and width W2 is approximately ½ of W1. This proportionality provides a stable transport platform while maintaining a relatively small size for apparatus 100.

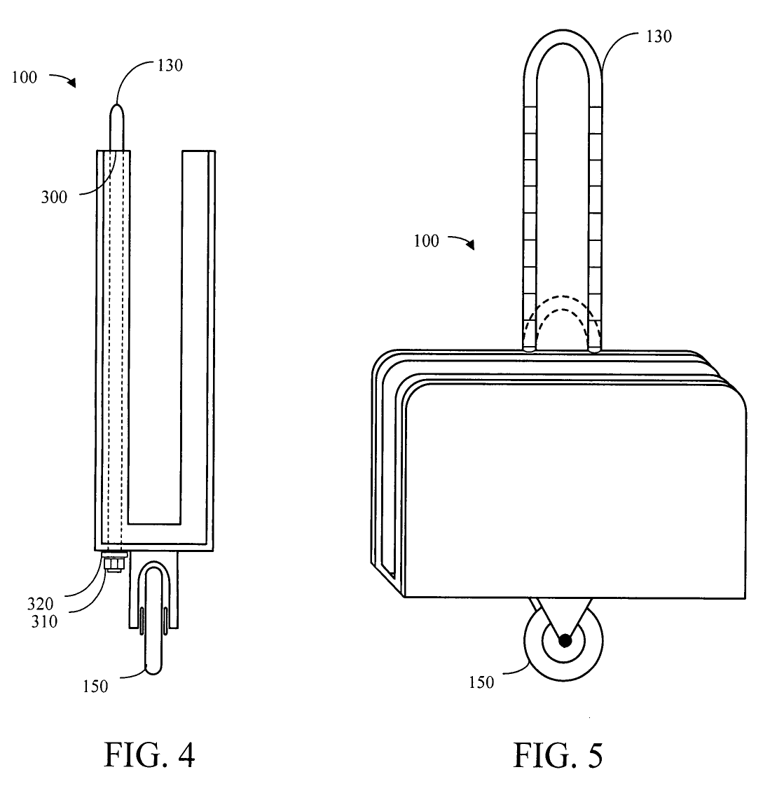

Referring now to FIG. 3 and FIG. 4, one method of attachment for securing telescoping handle 130 to apparatus 100 of FIG. 1 is presented in greater detail. As shown in FIG. 3, at least a portion of telescoping handle 130 passes through the interior space or body of liner 120 and is attached to the bottom of apparatus 100. In this fashion, the legs of telescoping handle 130 can be collapsed and substantially contained within the body of liner 120. By housing at least a portion of the extendable legs of telescoping handle 130 within liner 120, liner 120 additionally serves to provide structural support for the extendable legs of telescoping handle 130 to the extent that they pass through liner 120. The legs of telescoping handle 130 initially enter liner 120 through two liner apertures 300 and may be positioned at the center of either front or back side of liner 120. As shown in FIG. 3 and FIG. 4, attachment of the legs of telescoping handle 130 to liner 120 may be accomplished by securing a threaded portion of telescoping handle 130 to the underside of liner 120 with nuts 310 and washers 320.

In accordance with at least one alternative preferred embodiment of the present invention, telescoping handle 130 may be attached to liner 120 by welding the distal ends of the legs of telescoping handle 130 to the underside of apparatus 100. Those skilled in the art will recognize that the attachment method shown in FIG. 3 and other methods described herein (nuts, bolts, etc.) are only representative and many possible ways for attaching telescoping handle 130 exist. All such methods of attachment known to those skilled in the art are contemplated by and encompassed by the various preferred embodiments of the present invention.

Referring now to FIG. 5, apparatus 100 is depicted with optional telescoping handle 130 fully extended. In the most preferred embodiments of the present invention, telescoping handle 130 may be extended to any of several intermediate lengths, depending on the size of the material to be transported and may be stowed substantially within the body of apparatus 100 when not extended.

From the foregoing description, it should be appreciated that apparatus disclosed herein presents significant benefits over the known transport devices that would be apparent to one skilled in the art. Furthermore, while multiple embodiments have been presented in the foregoing description, it should be appreciated that a vast number of variations in the embodiments exist. Lastly, it should be appreciated that these embodiments set forth herein are preferred exemplary embodiments only, and are not intended to limit the scope, applicability, or configuration of the invention in any way. Rather, the foregoing detailed description provides those skilled in the art with a convenient road map for implementing one or more preferred exemplary embodiments of the invention. It should be understood that various changes may be made in the function and arrangement of elements described in the exemplary preferred embodiments without departing from the spirit and scope of the invention as set forth in the appended claims.

1. An apparatus comprising:
a substantially extruded u-shaped exterior;
a substantially extruded u-shaped liner affixed inside said substantially extruded u-shaped exterior; and
a single wheel mounted to said exterior.

2. The apparatus of claim 1 further comprising a plurality of screws coupling said exterior to said liner, each of said plurality of screws penetrating said exterior and penetrating at least a portion of said liner.

3. The apparatus of claim 1 wherein said exterior is fabricated from a metallic material.

4. The apparatus of claim 1 wherein said liner is fabricated from one of:
a durable plastic material;
a polymer material; and
a non-metallic material.

5. The apparatus of claim 1 wherein said apparatus has a length L1 and a width L2 and said wheel has a L2 and a width W2; and wherein said length L2 is approximately ⅓ of L1 and width W2 is approximately ½ of W1.

6. The apparatus of claim 1 further comprising a coupling mechanism coupled to said exterior.

7. The apparatus of claim 6 wherein said coupling mechanism comprises one of a clip, a hook, a button, a toggle, or a snap.

8. The apparatus of claim 1 further comprising a handle coupled to said exterior.

9. The apparatus of claim 8 wherein said handle is a telescoping handle.

10. The apparatus of claim 8 wherein said handle comprises a plurality of legs and wherein each of said legs are at least partially contained within said liner.

11. The apparatus of claim 10 further comprising a plurality of nuts and a plurality of bolts coupling said plurality of legs to said exterior.

12. An apparatus comprising:
a substantially extruded u-shaped metal exterior;
a substantially extruded u-shaped liner affixed inside said substantially extruded u-shaped exterior;
a plurality of screws coupling said exterior to said liner, each of said plurality of screws penetrating said exterior and penetrating at least a portion of said liner a wheel support coupled to said exterior;
a single wheel mounted within said wheel support;
a coupling mechanism coupled to said exterior;
a telescoping handle coupled to said exterior, said telescoping handle comprising a plurality of legs, said plurality of legs passing through said liner and wherein each of said plurality of legs are at least partially contained within said liner; and
a plurality of nuts and a plurality of bolts coupling said plurality of legs to said exterior.

13. The apparatus of claim 12 wherein said coupling mechanism comprises one of a clip, a hook, a button, a toggle, or a snap.

14. A method of transporting construction materials, said method comprising the steps of:
placing said construction materials into an apparatus for transporting construction materials, said apparatus comprising:
a substantially extruded u-shaped exterior;
a substantially extruded u-shaped liner affixed inside said a substantially extruded u-shaped exterior; and
a single wheel mounted to said exterior;
balancing said construction materials in said apparatus on said wheel; and
rolling said apparatus and said construction materials to a desired location.

15. The method of claim 14 further comprising the step of extending a telescoping handle, said telescoping handle being mounted to said exterior.

16. The method of claim 14 further comprising the steps of:
removing said construction materials from said apparatus; and
using a coupling mechanism to couple said apparatus to an operator's belt.

17. The method of claim 14 wherein said exterior is fabricated from a metallic material.

18. The method of claim 14 wherein said liner is fabricated from a durable plastic material.

19. The method of claim 14 further comprising the steps of:
removing said construction materials from said apparatus; and
using a coupling mechanism to couple said apparatus to an operator's belt.

20. The method of claim 19 wherein said coupling mechanism comprises one of a clip, a hook, a button, a toggle, or a snap.
